(19) United States
(12) Patent Application Publication
(10) Pub. No.: US 2024/0119098 A1
(43) Pub. Date: Apr. 11, 2024

(54) Systems and Methods for Providing Content to Users

(71) Applicant: Spotify AB, Stockholm (SE)

(72) Inventors: Daniel RUSSO, New York, NY (US); Yu ZHAO, Bromma (SE); Lucas MAYSTRE, London (GB); Shubham BANSAL, Jersey City, NJ (US); Sonia BHASKAR, Redwood City, CA (US); Tiffany WU, New York, NY (US); David GUSTAFSSON, Stockholm (SE); David BREDESEN, New York, NY (US); Roberto SANCHIS OJEDA, Barcelona (ES); Tony JEBARA, Monte Sereno, CA (US)

(21) Appl. No.: 18/472,919

(22) Filed: Sep. 22, 2023

Related U.S. Application Data
(60) Provisional application No. 63/409,138, filed on Sep. 22, 2022.

(51) Int. Cl. G06F 16/9535

(52) U.S. Cl. CPC G06F 16/9535

(57) ABSTRACT

The present application describes various methods and devices for providing content to users. In one aspect, a method includes, for each content item of a set of content items, obtaining a score for the content item using a recommender system, the score corresponding to a calculation of subsequent repeated engagement by a user with the content item. The method also includes ranking the set of content items based on the respective scores and providing recommendation information to the user for one or more highest ranked content items in the set of content items.

### PRIORITY AND RELATED APPLICATIONS

This application claims priority to U.S. Provisional Patent App. Ser. No. 63/409,138, filed Sep. 22, 2022, entitled “Systems and Methods for Providing Content to Users,” which is incorporated by reference herein in its entirety.

### TECHNICAL FIELD

The disclosed embodiments relate generally to media provider systems including, but not limited to, systems and methods for providing content recommendations for long-term user reengagement.

### BACKGROUND

Recent years have shown a remarkable growth in consumption of digital goods such as digital music, movies, books, and podcasts, among many others. The overwhelmingly large number of these goods often makes navigation and discovery of new digital goods an extremely difficult task. Recommender systems commonly retrieve preferred items for users from a massive number of items by modeling users' interests based on historical interactions.

Many existing recommendation algorithms are optimized to drive short-term outcomes, such as maximizing clicks or 30-second streams. These algorithms may drive immediate interaction with content, but generally don't consider longer-term behaviors and habits such as repeat consumption or retention. Many recommendation systems rely on machine learning algorithms that are trained to optimize short-term metrics that represent an imperfect reflection of a recommendation's impact on a user's long-term satisfaction. Reinforcement learning (RL) approaches are capable of addressing long-term optimization, but there are significant challenges with measurement, attribution, and coordination. Proxy approaches require manual identification of proxies and don't scale to large catalogs.

### SUMMARY

The present disclosure describes, among other things, providing content recommendations to drive longer-term behaviors and build user habits (e.g., promote repeat engagement of user with content over multiple weeks). Some embodiments include training a machine learning (ML) model to rank content items for a given user based on an expected consumption they will drive for the user over a multi-day (e.g., 30, 60, or 90 days) future window. Some embodiments include combining the ML model outputs with outputs from a short-term optimized recommendation engine to modulate the engine rankings to increase the rank of content with higher longer-term engagement.

The systems and methods described herein differ from conventional applications of reinforcement learning (RL) to recommender systems as the disclosed architectures and procedures address the measurement and coordination challenges that can limit other RL approaches. For example, some of the disclosed systems decompose outcomes into multiple stages (e.g., short-term and long-term) and train separate subsystems (e.g., with separate datasets) for each stage. For example, rather than predict long-term outcomes that follow from a recommendation directly, the disclosed systems may predict indirectly (e.g., with a long-term value subsystem that leverages data collected outside of the recommender system itself). The disclosed systems are therefore able to operate with long-term goals defined on longer time frames (e.g., 30, 60, or 90 days).

Additionally, the disclosed systems can be applied to multiple distinct surfaces (e.g., distinct user interfaces, distinct applications, distinct experiences, and/or other types of surfaces), with different surface-specific subsystems (e.g., short-term recommenders), by sharing the long-term value subsystem across all surfaces.

The disclosed systems and procedures also differ from the set of approaches that fall under the term surrogate/proxy metrics (e.g., functions of short-term outcomes that appear to align decisions with long-term goals). For example, the disclosed systems may include optimized ML models of long-term value from data, as opposed to hand-crafted proxies. As another example, the disclosed systems may explicitly optimize for the long-term goal, as opposed to using surrogates that are hopefully aligned with the long-term goal.

In accordance with some embodiments, a method of providing content to users includes: (i) obtaining a request to provide one or more content item recommendations to a user; (ii) for each content item of a set of content items: (a) acquiring a first score for the content item using a first recommender system, the first score corresponding to a probability of a selection by the user of the content item; (b) acquiring a second score for the content item using a second recommender system, the second score corresponding to repeated engagement by the user with the content item; and (c) assigning a combined score to the content item by aggregating the first score and the second score; and (iii) ranking the set of content items in accordance with the respective combined scores; and (iv) in response to the request, providing recommendation information for one or more highest ranked content items in the set of content items.

In accordance with some embodiments, a method of providing content to users includes: (i) for each content item of a set of content items, obtaining a score for the content item using a recommender system, the score corresponding to a calculation of subsequent reengagement by a user with the content item; (ii) ranking the set of content items based on the respective scores; and (iii) providing recommendation information to the user for one or more highest ranked content items in the set of content items.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein.

Thus, devices and systems are disclosed with methods for recommending and providing content. Such methods, devices, and systems may complement or replace conventional methods, devices, and systems for recommending and providing content.

### BRIEF DESCRIPTION OF THE DRAWINGS

The embodiments disclosed herein are illustrated by way of example, and not by way of limitation, in the figures of the accompanying drawings Like reference numerals refer to corresponding parts throughout the drawings and specification.

FIG. 1 is a block diagram illustrating a media content delivery system in accordance with some embodiments.

FIG. 2 is a block diagram illustrating an electronic device in accordance with some embodiments.

FIG. 3 is a block diagram illustrating a media content server in accordance with some embodiments.

FIG. 4A is a diagram illustrating recommendation outcomes over time in accordance with some embodiments.

FIG. 4B illustrates a user engagement example in accordance with some embodiments.

FIG. 4C illustrates an example table of user engagement in accordance with some embodiments.

FIG. 5 is a flow diagram illustrating an example method of providing content to a user in accordance with some embodiments.

### DETAILED DESCRIPTION

The present application describes, among other things, systems, devices, and methods of driving long-term content engagement by modeling long-term as well as short-term user behavior patterns. Recommending content that a user is likely to reengage with in the future improves the efficiency of man-machine interface (e.g., by reducing the number of user inputs) and improves user satisfaction (e.g., by presenting the user with content that they want to continue to engage with).

As described in greater detail below, recommendations and content may be presented to the user based on outputs from a long-term recommender system (e.g., a surface-independent recommender system). Because the long-term recommender system may be surface-independent, the same long-term recommender system may be used for multiple surfaces (rather than having to train multiple surface-specific recommender systems). As also described in greater detail below, outputs from a short-term recommender system (e.g., a surface-specific recommender system) may be combined with outputs from the long-term recommender system. The short-term recommender system and the long-term recommender system may be trained on different types of data (e.g., different training sets). As also described in greater detail below, a combined recommender system may be trained to rank content items (e.g., series of shows, series of podcasts, books, book series, and/or music playlists). In this way, recommendations and/or ranks may be determined before receiving a recommendation request (e.g., pre-calculated rather than calculated in real time after a request is received).

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

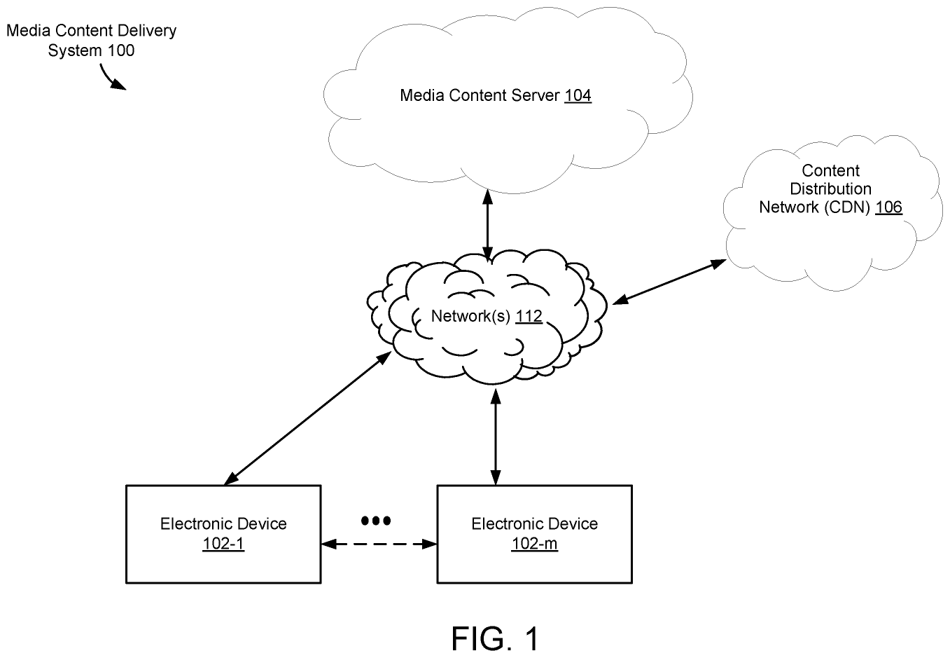

FIG. 1 is a block diagram illustrating a media content delivery system 100 in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. The one or more networks 112 communicably couple the components of the media content delivery system 100. In some embodiments, the one or more networks 112 include public communication networks, private communication networks, or a combination of both public and private communication networks. For example, the one or more networks 112 may be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of content items, such as music tracks, podcasts, videos, etc.). The electronic devices 102 may connect to each other wirelessly and/or through a wired connection (e.g., directly through an interface, such as an HDMI interface). In some embodiments, the electronic devices 102-1 and 102-m are the same type of device (e.g., the electronic device 102-1 and the electronic device 102-m are both speakers). Alternatively, the electronic device 102-1 and the electronic device 102-m include two or more different types of devices.

In some embodiments, the electronic devices 102-1 and 102-m send and receive media-control information through the network(s) 112. For example, the electronic devices 102-1 and 102-m send media control requests (e.g., requests to play music, podcasts, movies, videos, or other content items, or playlists thereof) to the media content server 104 through the network(s) 112. Additionally, the electronic devices 102-1 and 102-m, in some embodiments, also send indications of media content items to the media content server 104 through the network(s) 112. In some embodiments, the media content items are uploaded to the electronic devices 102-1 and 102-m before the electronic devices forward the media content items to the media content server 104.

In some embodiments, the electronic device 102-1 communicates directly with the electronic device 102-m (e.g., as illustrated by the dotted-line arrow), or any other electronic device 102. As illustrated in FIG. 1, the electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with the electronic device 102-m. In some embodiments, the electronic device 102-1 communicates with the electronic device 102-m through the network(s) 112. In some embodiments, the electronic device 102-1 uses the direct connection with the electronic device 102-m to stream content (e.g., data for content items) for playback on the electronic device 102-m.

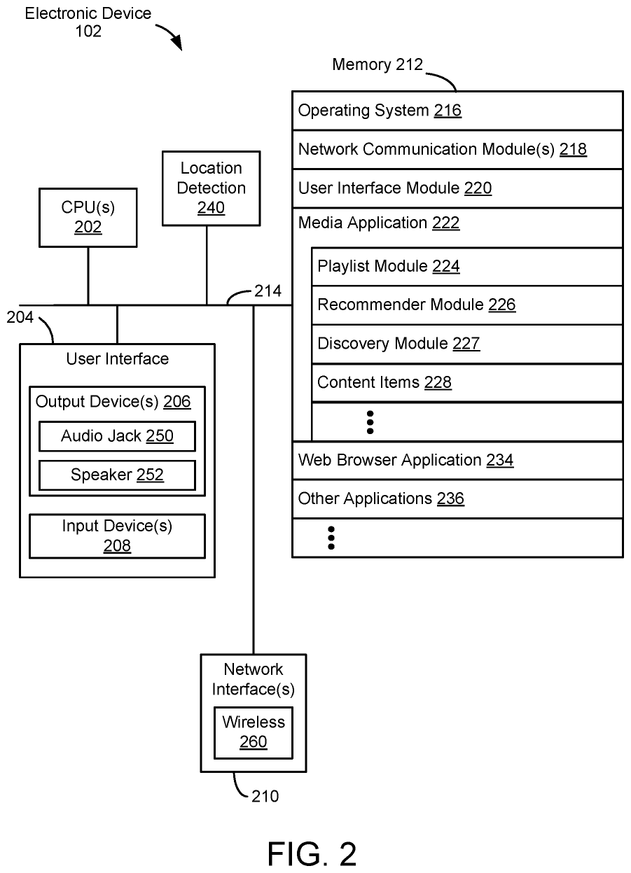

In some embodiments, the electronic device 102-1 and/or the electronic device 102-m include a media application 222 (FIG. 2) that allows a respective user of the respective electronic device to upload (e.g., to the media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, the electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio content items (also referred to herein as “audio items,” “tracks,” and/or “audio tracks”).

In some embodiments, the media content server 104 receives media requests (e.g., commands) from the electronic devices 102. In some embodiments, the media content server 104 includes a voice API, a connect API, and/or key service. In some embodiments, the media content server 104 validates (e.g., using key service) the electronic devices 102 by exchanging one or more keys (e.g., tokens) with electronic device(s) 102.

In some embodiments, the media content server 104 and/or the CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to the CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., the electronic device 102-1 and/or the electronic device 102-m, FIG. 1), in accordance with some embodiments. The electronic device 102 includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., the output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, the electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

The memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. The memory 212 may optionally include one or more storage devices remotely located from the CPU(s) 202. The memory 212, or alternately, the non-volatile memory solid-state storage devices within the memory 212, includes a non-transitory computer-readable storage medium. In some embodiments, the memory 212 or the non-transitory computer-readable storage medium of the memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), the media content server 104, and/or other client devices) via the one or more network interface(s) 210 (wired or wireless) connected to the one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with the media content server 104) for uploading, browsing, receiving, processing, presenting, and/or requesting playback of media (e.g., content items). In some embodiments, the media application 222 includes a media player, a streaming media application, and/or any other appropriate application or component of an application. In some embodiments, the media application 222 is used to monitor, store, and/or transmit (e.g., to the media content server 104) data associated with user behavior. In some embodiments, the media application 222 also includes the following modules (or sets of instructions), or a subset or superset thereof:
   a playlist module 224 for storing sets of content items for playback in a predefined order;
   a recommender module 226 for identifying and/or displaying recommended content items to include in a playlist;
   a discovery model 227 for identifying and presenting (new) content items to a user;
   a content items module 228 for storing content items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

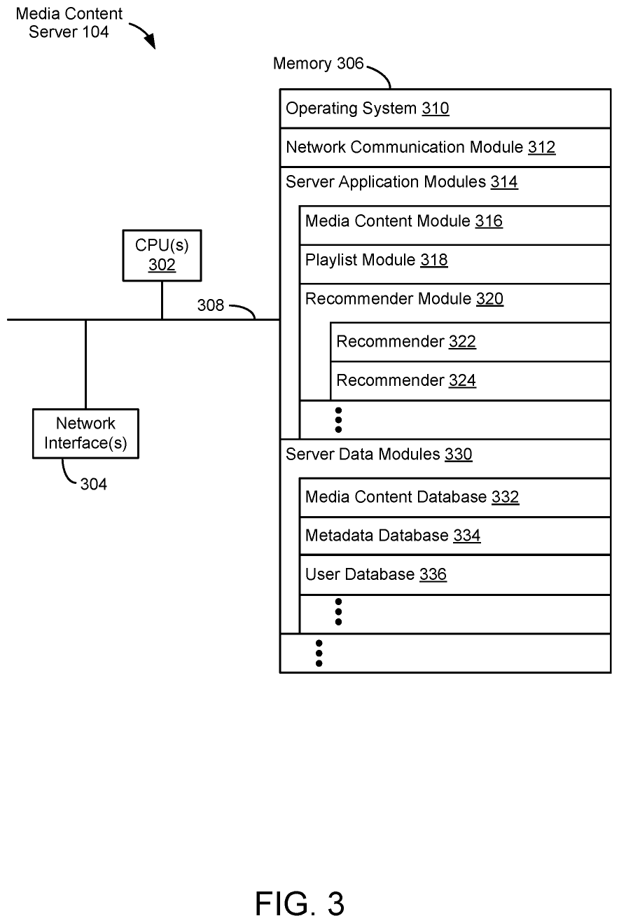

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

The memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. The memory 306 optionally includes one or more storage devices remotely located from one or more CPUs 302. The memory 306, or, alternatively, the non-volatile solid-state memory device(s) within the memory 306, includes a non-transitory computer-readable storage medium. In some embodiments, the memory 306, or the non-transitory computer-readable storage medium of the memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via the one or more network interfaces 304 (wired or wireless) connected to the one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device;
   a recommender module 320 for determining and/or providing recommendations for a content item and/or a sequence of content items (e.g., a playlist or episode list). In some embodiments, the recommender module 320 includes a recommender 322 for short-term-based recommendations and a recommender 324 for long-term-based recommendations; and
one or more server data module(s) 330 for handling the storage of and/or access to content items and/or metadata relating to the content items; in some embodiments, the one or more server data module(s) 330 include:
   a media content database 332 for storing content items; in some embodiments, the media content database 332 includes one or more sets of content items and/or content item vectors for the one or more sets of content items;
   a metadata database 334 for storing metadata relating to the content items, such as a genre, performer, or producer associated with the respective content items; and
   a user database 336 for storing user profile data, historical usage data, and/or preferences data. In some embodiments, the user database 336 stores one or more user vectors for each user.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in the memory 212 and 306 corresponds to a set of instructions for performing a function described herein. The above identified modules or programs (e.g., sets of instructions) need not be implemented as separate software programs, procedures, or modules, and thus various subsets of these modules may be combined or otherwise re-arranged in various embodiments. In some embodiments, the memory 212 and 306 optionally store a subset or superset of the respective modules and data structures identified above. Furthermore, the memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, the media content database 332 and/or the metadata database 334 are stored on devices (e.g., the CDN 106) that are accessed by the media content server 104. The actual number of servers used to implement the media content server 104, and how features are allocated among them, will vary from one implementation to another and, optionally, depends in part on the amount of data traffic that the server system handles during peak usage periods as well as during average usage periods.

A recommendation system can interact with users across many time periods (e.g., with a day representing an example time period). Recommendations can be interpreted as being encoded in a one-dimensional feed which a user scrolls through in sequence. Many recommendations are skipped by the user without much thought given. When a user does engage with a recommendation (e.g., streams, watches, and/or listens to the corresponding content item), the recommender may observe how long they listen. The feed itself can be interpreted as a long sequence of items a user will be recommended during a given time period. In some embodiments, the recommender does not adjust a recommendation based on a user's responses to content items recommended earlier in the same period. A content item may appear multiple times on the feed, reflecting that a user may see the same recommendation multiple times within a day. The same content item (or segments of the same content item) may be recommended and streamed on multiple days. The content item may be a playlist of songs (which can be repeatedly consumed) or a podcast or show (which may have new episodes released on a regular cadence). The recommender may also have access to historical data (e.g., reflecting the performance of a behavioral (status-quo) policy). In some embodiments, an algorithm is used to determine the choice of recommendations in various positions of the feed. As described in greater detail below, the algorithm may include differentiated logic for determining the recommendation on the feed at a single, specified position.

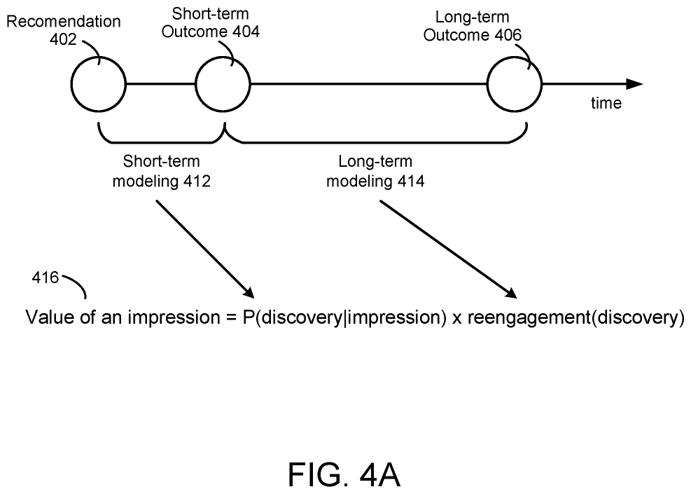

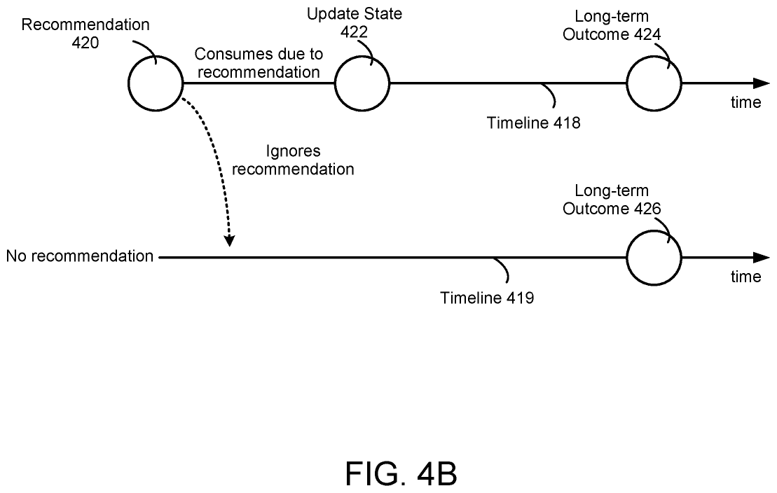

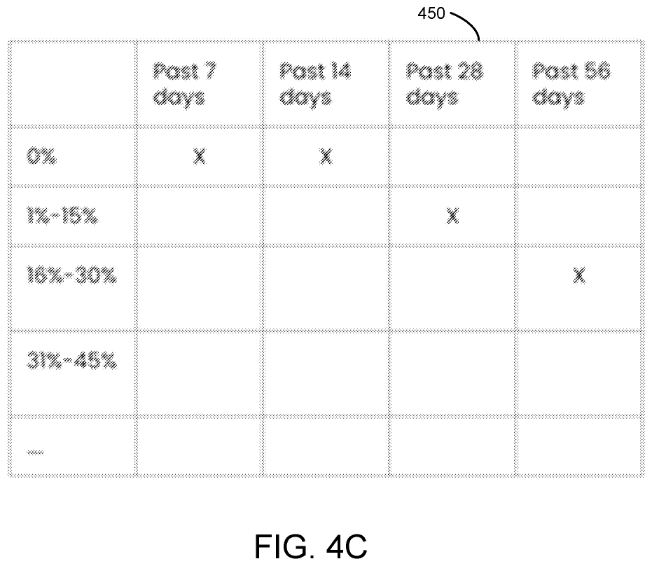

FIG. 4A is a diagram illustrating recommendation outcomes over time in accordance with some embodiments. At a first time, a recommendation 402 for to a content item is provided. For example, the recommendation 402 is provided at a particular user interface or other surface. At a second time, a short-term outcome 404 is determined. For example, the short-term outcome 404 may be a user selection of the recommendation, a user engaging with the content item for at least a preset amount of time, and/or a user indicating an interest in the content item (e.g., liking, favoriting, and/or adding the content item to a playlist). Additionally, the short-term outcome 404 may be the user not engaging with the content item (e.g., disregarding the recommendation 402). At a third time, a long-term outcome 406 is determined. For example, the long-term outcome 406 may be a count of how many times the user reengaged with the content item during a preset period of time, a measure of how long the user reengaged with the content item during the preset period of time, and/or a measure of how long between an initial engagement (e.g., corresponding to the short-term outcome 404) and a reengagement. The long-term outcome 406 can be interpreted as an indication a user's habits.

The short-term outcome 404 may be calculated (predicted) via short-term modeling 412 (e.g., using a short-term recommender) and the long-term outcome 406 may be calculated (predicted) via long-term modeling 414 (e.g., using a long-term recommender). FIG. 4A also shows that a value 416 of an impression may be determined based on a combination of the short-term modeling 412 and the long-term modeling 414. The impression may be a home screen recommendation or a personalized search result. The value 416 in FIG. 4A corresponds to a value for a content item with which the user has not previously engaged (e.g., a discovery item). For example, the value 416 corresponds to an assumption that the user would not engage with the content item in the absence of a recommendation. In some embodiments, respective values 416 for a set of content items are used to rank the set of content items. In some embodiments, the short-term modeling 412 outputs a probability of a user engaging with an impression, denoted as P(discovery|impression) in FIG. 4A. In some embodiments, the long-term modeling 414 outputs a measure of subsequent reengagement with the content item, denoted as reengagement(discovery) in FIG. 4A. For example, the long-term modeling 414 may return a predicted number of days that a user engages with the content item during a future time period (e.g., 60 days).

In some embodiments, the short-term modeling 412 and the long-term modeling 414 correspond to distinct systems that are trained independently. In some embodiments, the short-term modeling 412 includes a model that predicts an immediate outcome (e.g., a selection or not) that follows a system action (e.g., a decision to recommend something). In some embodiments, the inputs to the short-term modeling 412 include information about the user, information about the content that is being recommended, and information about the current context (e.g., how many times the user has streamed the content before). In some embodiments, the outputs of the short-term modeling 412 include a probability distribution over outcomes (e.g., the probability of an impression/selection).

In some embodiments, the long-term modeling 414 includes a model that predicts how an immediate outcome (such as a decision to select a piece of content) affects a user's habits. In some embodiments, the inputs to the long-term modeling 414 include information about the user, content, and context as well as information about the type of short-term outcome (e.g., did the user select the content item, did the user watch/listen to the entire item, and/or did the user add the content to a favorites list). In some embodiments, the outputs of the long-term modeling 414 include the expected change in habits caused by the short-term outcome (e.g., the number of days a user will stay engaged with a show). In some embodiments, a model (e.g., a lifetime value (LTV) model) is used to predict how a user's habits affect their retention with an application, service, or surface. In some embodiments, an LTV model is used to identify which habits are important to consider in the long-term modeling 414.

The short-term modeling 412 and the long-term modeling 414 can be independent and separate (e.g., the corresponding models are trained separately by different teams and using different data). Separately training the models allows for training on specific data that can improve accuracy, efficiency, and user satisfaction. For example, training the short-term modeling 412 on surface-specific data and the long-term modeling 414 on all data collected across a platform, predictions that are much more accurate and useful can be obtained. Separately training the models also allows for better scalability in users and content items.

FIG. 4B illustrates a user engagement example in accordance with some embodiments. In the example of FIG. 4B, two timelines are presented, a timeline 418 and a timeline 419. In the timeline 418, the user receives a recommendation 420 for a content item (with which the user has previously engaged) at a first time and, in response, reengages with the content item. In the timeline 419, the user does not receive a recommendation for the content item. In the example of FIG. 4B, the user ignoring the recommendation 420 causes a transition from the timeline 418 to the timeline 419. In the timeline 418, after the user reengages due to the recommendation 420, a state 422 is updated (e.g., incremented by 1) to indicate the reengagement. In the timeline 418, a long-term outcome 424 is determined at a second time (e.g., at the end of a preset amount of time). In the timeline 419, a long-term outcome 426 is determined at the second time. A difference between the long-term outcome 424 and the long-term outcome 426 can be used to indicate the long-term impact of the recommendation 420. In some embodiments, a long-term recommender is configured to calculate (predict) the difference in long-term outcomes with and without a recommendation to provide a recommendation score for a content item. In some embodiments, a compact description of the content-state (e.g., a summary of the history of a user's past engagement with that content) is used for content with which the user has previously engaged. In some embodiments, exponential moving averages at different timescales is used to describe the content state.

In accordance with some embodiments, a change in value due to a successful recommendation is represented in Equation 1 below.

change in value=1+δV/(s⁺)−V(s) Equation 1—Recommendation Change in Value

where V( ) is a value function, and δ is a discount factor (controlling the trade-off between short term and long term). For example, setting δ close to zero leads to optimizing for the short term and setting δ close to one leads to optimizing for the long term. In some embodiments, δ is set to close to one (e.g., 0.9 or 0.95). In Equation 1, 1+δV/(s⁺) represents a trajectory of a re-engaged user (e.g., the timeline 418) and V(s) represents a passive user trajectory (e.g., the timeline 419). A value of a content item impression may be expressed as a probability of engagement times a change in value due to the engagement (e.g., in accordance with Equation 1 above).

In some embodiments, a content item score, score(a_{*}), is determined using Equation 2 below.

$$Content Item Score$$

$$score ( {a}_{*} ) = {λ}_{{a}_{*}} {\sum }_{c} [ ℙ ( {C}_{{a}_{*}} = c \vert \hat{u} , {A}_{*} = {a}_{*} ) - ℙ ( {C}_{{a}_{*}} = c \vert \hat{u} , {A}_{*} \neq {a}_{*} ) ] \times [ \text{} r ( c ) + δ {\hat{V}}_{π}^{( {a}_{*} )} ( ϕ ( {Z}_{{a}_{*}} , c ) , \hat{ω} ) ] \qquad Equation 2$$

where λ_{a*} is a weighting factor, C_{a*} denotes the short-term outcome (e.g., describing how the user engages with the content _{a*} initially) (e.g., is an indicator of consumption), û is a user vector, A_{*} is the selected recommendation, c is an indicator of consumption (an outcome), r(c) is a reward associated with outcome c, \hat{V}_{π}^{(a*)} is a measure of future (e.g., long-term) re-engagement, ϕ is an encoding/mapping function, and Z_{a*} is the user's content state, and \hat{ω} is a vector (e.g., an embedded vector) computed based on a user's interaction history. In Equation 2, [ [symbol] (C_{a*}=c|û, A_{*}=a_{*})− [symbol] (C_{a*}=c|û,A_{*}≠a_{*})] represents the impact of a recommendation on short-term outcomes and [r(c)+δ\hat{V}_{π}^{(a*)}(ϕ(Z_{a*},c),\hat{ω})] represents the long-term value of outcome c. In some embodiments, the score is used to rank recommendation candidates (e.g., a set of content items). In some embodiments, ϕ is learned (e.g., by training a recurrent neural network).

In some embodiments, û is a user vector used for short-term modelling. In some embodiments, û is an embedded vector computed based on a user's interaction history and/or context information (e.g., current device and/or time of day). The vector û can be interpreted as an understanding of a user's preferences at a current moment. In some embodiments, û is encoding using the last hidden layer of a deep-learning network. In some embodiments, \hat{ω} is a user vector used for long-term modelling. In some embodiments, \hat{ω} is an embedded vector computed based on a user's interaction history (e.g., over a longer time period than the interaction history for û). The vector \hat{ω} can be interpreted as a user's long-term taste preferences. In some embodiments, Z_{a*} is a k-dimensional embedded representation of a user's consumption history of each piece of content item.

In some embodiments, Equation 2 for content item scoring is simplified for discovery cases (e.g., where a user has no prior engagement with the recommended item). Equation 3, below, provides a content item score for a discovery item.

$$Discovery Content Item Score$$

$$score ( {a}_{*} ) = {λ}_{{a}_{*}} {\sum }_{c} [ ℙ ( {C}_{{a}_{*}} = c \vert \hat{u} , {A}_{*} = {a}_{*} ) ] \times [ 1 + {\hat{V}}^{( {a}_{*} )} ( \hat{ω} ) ] \qquad Equation 3$$

In some embodiments, the long-term engagement portion (1+\hat{V}^{(a*)}(\hat{ω})) is implemented as a dot product between \hat{ω} and a learned show vector.

FIG. 4C illustrates a table 450 of user engagement in accordance with some embodiments. In some embodiments, a user's content-state with a particular piece of content can be visualized as a table as shown in FIG. 4C. The table 450 in FIG. 4C shows that a user has engaged with a content item in a 16%-30% range during the past 56 days (e.g., engaged with the content item for at least a preset amount of time on 16%-30% of the past 56 days). The table 450 further shows that the user has engaged with the content item in the 1%-15% range in the past 28 days, and in the 0% range for the past 14 and 7 days. Thus, the example of FIG. 4C shows a user's engagement decreasing over a 56-day period with no engagement for the recent two weeks. In some embodiments, the content items include podcasts, shows, music, and/or audiobooks.

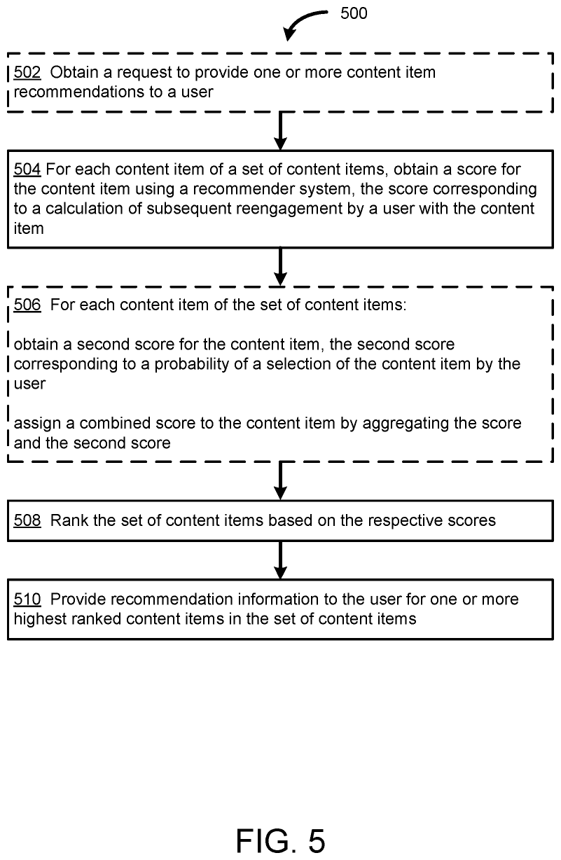

FIG. 5 is a flow diagram illustrating a method 500 of providing content to a user in accordance with some embodiments. The method 500 may be performed at a computing system (e.g., the media content server 104 and/or the electronic device(s) 102) having one or more processors and memory storing instructions for execution by the one or more processors. In some embodiments, the method 500 is performed by executing instructions stored in the memory (e.g., the memory 212, FIG. 2 and/or the memory 306, FIG. 3) of the computing system. In some embodiments, the method 500 is performed by a combination of the server system (e.g., including the media content server 104 and/or the CDN 106) and a client device. For clarity, the method 500 is described below as being performed by a system.

In some embodiments, the system obtains (502) a request to provide one or more content item recommendations to a user. In some embodiments, the request corresponds to a request from an application executing on a client device of the user (e.g., the electronic device 102).

For each content item of a set of content items, the system obtains (504) a score for the content item using a recommender system (e.g., the recommender 322), the score corresponding to a calculation of subsequent reengagement by a user with the content item. For example, the score corresponds to a long-term output and/or reengagement. In some embodiments, the set of content items includes one or more podcasts, shows, audiobooks, and/or music items. In some embodiments, the set of content items includes content items with which the user has not previously interacted (e.g., discovery content). In some embodiments, the recommender system is trained using a reward function. For example, a holistic reward function may be used to associate a user's daily interactions with a measure of success.

In some embodiments, the score for each content item is based on information about the user, information about the content item, context information, and information about types of short-term outcomes for content items. In some embodiments, the types of short-term outcomes include one or more of: a user selecting the content item to watch, a user watching the content item, and a user adding the content item to a favorites list. In some embodiments, the score corresponds to a likelihood of the content item affecting a habit of the user. In some embodiments, the score is based on information from another recommender system, the other recommender system configured to identify user habits that correspond to repeated content item engagement by the user. In some embodiments, the score for each content item is based on (i) the calculation of subsequent reengagement by a user with the content item and (ii) a probability of a selection of the content item by the user. In some embodiments, the score is calculated from a combination of a user vector for the user and a content item vector for the content item. In some embodiments, the calculation of subsequent reengagement comprises a calculation of a number of times the user will reengage with the content item during a future time period. In some embodiments, reengaging with the content item comprises playing back content of the content item for at least a preset amount of time. In some embodiments, the calculation of subsequent reengagement comprises a calculation of an amount of time the user will engage with the content item during a future time period. In some embodiments, the calculation of subsequent reengagement comprises a calculation of an amount of time that will elapse before the user reengages with the content item. In some embodiments, the score for the content item comprises a difference score for reengagement, wherein the difference score corresponds to a difference between a first reengagement score without a recommendation and a second reengagement score with the recommendation.

In some embodiments, for each content item of the set of content items, the system obtains (506) a second score for the content item, the second score corresponding to a probability of a selection of the content item by the user and assigns a combined score to the content item by aggregating the score and the second score (e.g., using the recommender module 320). For example, the second score corresponds to a short-term output and/or a surface estimate. In some embodiments, the second score for each content item is based on information about the user, information about the content item, and context information. In some embodiments, the context information includes information about the user's historical interactions with the content item. In some embodiments, the second score for the content item is obtained from a second recommender system (e.g., the recommender 324), different than the recommender system.

The system ranks (508) the set of content items based on the respective scores (e.g., using the recommender module 320). In some embodiments, the ranking is in accordance with the respective combined scores. For example, the set of content items are ranked such that the content items with the highest scores are the highest ranked.

The system provides (510) recommendation information to the user for the one or more highest ranked content items in the set of content items. In some embodiments, the system provides the recommendation information in response to a request for a recommendation. For example, the system provides the highest ranked content item to the user in a home page recommendation and/or search result. For example, the server 104 may provide the recommendation information to the electronic device 102 via the network communication module 312 and the network interface 304.

Although FIG. 5 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

(A1) In one aspect, some embodiments include a method (e.g., the method 500) of providing content to a user. In some embodiments, the method is performed at a computing system (e.g., the media content server 104, the CDN 106, and/or the electronic device(s) 102) having memory and control circuitry. In some embodiments, the method is performed at a recommender module (e.g., the recommender module 226 and/or the recommender module 320). The method includes: (i) for each content item of a set of content items, obtaining a score for the content item using a recommender system, the score corresponding to a calculation of subsequent repeated engagement by a user with the content item; (ii) ranking the set of content items based on the respective scores; and (iii) providing recommendation information to the user for one or more highest ranked content items in the set of content items. In some embodiments, the method is performed at a server system. In some embodiments, the method is performed at a client device. For example, the score predicts how many times the user will engage with one or more segments of the content item during a future time period. In some embodiments, the score is a reengagement score (e.g., a measure of whether the user will continue to engage with the content). In some embodiments, the ranking is further based on (e.g., constrained by) a preset percentage of content types (e.g., corresponding to a content distribution for the user). In some embodiments, the ranking is based on a short-term outcome (e.g., clickthrough rate) and a long-term outcome (e.g., the subsequent repeated engagement). In some embodiments, the recommender system is surface-independent (e.g., is independent of how the user initially engaged with a content item).

(A2) In some embodiments of A1, the score is calculated from a combination of a user vector for the user and a content item vector for the content item. In some embodiments, the combination is a dot product or other simple product. In some embodiments, each content item in the set of content items has a distinct content item vector. In some embodiments, a content item vector corresponds to a set of segments (e.g., episodes, chapters, or songs) for the content item (e.g., less than all of the segments for the content item). In some embodiments, the user vector is a representation of an individual user. In some embodiments, the user vector is a representation of a group of similar users (e.g., a cohort of users with similar traits/preferences). In some embodiments, the user vector includes a component indicating a number of times the user has previously engaged with the content item. In some embodiments, the content item vector includes one or more components that are specific to a particular segment of the content item (e.g., a show-specific vector). In some embodiments, the content item vector includes two or more values and indicates a type of user (e.g., a user cohort) that engages with the content item. In some embodiments, the user vector represents user characteristics (e.g., user preferences, user habits, user demographics, and/or prior user behavior.

(A3) In some embodiments of A1 or A2, the method further includes receiving a request to provide one or more recommendations to the user, wherein the recommendation information is provided in response to receiving the request. In some embodiments, the request is received from a client device of the user.

(A4) In some embodiments of any of A1-A3, the calculation of subsequent repeated engagement comprises a calculation (e.g., a prediction) of a number of times the user will reengage with the content item during a future time period. For example, the future time period may be 3 days, 10 days, 30 days, 60 days, or 90 days. As an example, the number of times is a number of days in which the user will engage with the content item (for at least a preset amount of time) during the future time period. In some embodiments, the score is a number (e.g., a positive integer) representing a number of times the user is predicted to reengage with the content item during a future time period.

(A5) In some embodiments of A4, reengaging with the content item comprises playing back content of the content item for at least a preset amount of time. For example, the preset amount of time may be 1 minute, 2 minutes, 10 minutes, 30 minutes, or 60 minutes. In some embodiments, reengaging with the content item comprises playing back at least a preset percentage of a segment of the content item (e.g., at least 30%, 50%, 70%, or 90%).

(A6) In some embodiments of any of A1-A5, the calculation of subsequent repeated engagement comprises a calculation of an amount of time the user will engage with the content item during a future time period. For example, a number of minutes the user spends watching/listening to the content item during the future time period.

(A7) In some embodiments of any of A1-A6, the calculation of subsequent repeated engagement comprises a calculation of an amount of time that will elapse before the user reengages with the content item. For example, the calculation is a number of days before the user is predicted to reengage with the content item.

(A8) In some embodiments of any of A1-A7, the method further includes, for each content item of a set of content items: (i) obtaining a second score for the content item, the second score corresponding to a probability of a selection of the content item by the user; and (ii) assigning a combined score to the content item by aggregating the score and the second score, where the ranking of the set of content items is in accordance with the respective combined scores. In some embodiments, the second score comprises a probability. For example, a probability that a user will take an action (e.g., selecting the content item, favoriting the content item, or playing back the content item) in response to an impression. In some embodiments, the second score is calculated from a combination of a second user vector for the user and a second content item vector for the content item. The second user vector for the second score may be the same or different than a user vector for the (first) score. In some embodiments, different user vectors are used for the different scores to tailor the comparison for each recommender system. The second content item vector for the second score may be the same or different than a content item vector for the (first) score. In some embodiments, different content item vectors are used for the different scores to tailor the comparison for each recommender system (e.g., training on whether a user took an action after an impression or training on whether a user reengaged with a content item after an initial engagement. In some embodiments, the combined score is calculated in response to request to provide a recommendation to the user. In some embodiments, the combined score is calculated before receiving a request to provide a recommendation.

(A9) In some embodiments of A8, the second score for the content item is obtained from a second recommender system, different than the recommender system. In some embodiments, the second recommender system is trained on impression data. In some embodiments, the second recommender system is trained on a first type of data (e.g., local context data for each action) and the recommender system is trained on a second type of data (e.g., excluding local context data for the actions). For example, the recommender system may be independent of the context in which a user action occurs (e.g., training on what occurs after the user action). In some embodiments, the recommender system and the second recommender system are trained on different timescales.

(A10) In some embodiments of A8 or A9, the second score for each content item is based on information about the user, information about the content item, and context information. In some embodiments, the context information includes information about the user's historical interactions with the content item.

(A11) In some embodiments of any of A1-A8, the score for each content item is based on (i) the calculation of subsequent repeated engagement by a user with the content item and (ii) a probability of a selection of the content item by the user. In some embodiments, the recommender system is trained on combined scores that account for short-term and long-term outcomes.

(A12) In some embodiments of any of A1-A11, the score for each content item is based on information about the user, information about the content item, context information, and information about types of short-term outcomes for content items.

(A13) In some embodiments of A12, the types of short-term outcomes include one or more of: a user selecting the content item to watch, a user watching the content item, and a user adding the content item to a favorites list.

(A14) In some embodiments of any of A1-A13, the set of content items includes one or more of: a podcast series, a show series, an audiobook series, and a music playlist.

(A15) In some embodiments of any of A1-A14, the score for each content item corresponds to a likelihood of consumption of the content item affecting a habit of the user.

(A16) In some embodiments of any of A1-A15, the set of content items comprises content items not previously engaged with by the user. For example, content the user has not previously watched, listened to, or otherwise consumed.

(A17) In some embodiments of any of A1-A16, the recommender system is trained using a reward function. For example, the reward function outputs a 1 if the user reengages with a content segment and outputs a 0 if the user does not reengage with the content segment.

(A18) In some embodiments of any of A1-A19, the score for the content item comprises a difference score for reengagement, and the difference score corresponds to a difference between a first reengagement score without a recommendation and a second reengagement score with a recommendation. In some embodiments, a first user vector is used for calculating the first reengagement score, the first user vector indicating a number of times the user previously engaged with the content item. In some embodiments, a second user vector is used for calculating the second reengagement score, the second user vector indicating an incremented number of times the user has engaged with the content item (e.g., the number of times previously engaged with the content item plus one for the recommendation-based engagement.

In another aspect, some embodiments include a computing system (e.g., the media content server 104 and/or the electronic device(s) 102) including control circuitry (e.g., the CPU(s) 202 and/or 302) and memory (e.g., the memory 212 and/or 306) coupled to the control circuitry, the memory storing one or more sets of instructions configured to be executed by the control circuitry, the one or more sets of instructions including instructions for performing any of the methods described herein (e.g., A1-A18 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A18 above).

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method of providing content to users, the method comprising:
for each content item of a set of content items, obtaining a score for the content item using a recommender system, the score corresponding to a calculation of subsequent reengagement by a user with the content item;
ranking the set of content items based on the respective scores; and
providing recommendation information to the user for one or more highest ranked content items in the set of content items.

2. The method of claim 1, wherein the score is calculated from a combination of a user vector for the user and a content item vector for the content item.

3. The method of claim 1, further comprising receiving a request to provide one or more recommendations to the user, wherein the recommendation information is provided in response to receiving the request.

4. The method of claim 1, wherein the calculation of subsequent reengagement comprises a calculation of a number of times the user will reengage with the content item during a future time period.

5. The method of claim 4, wherein reengaging with the content item comprises playing back content of the content item for at least a preset amount of time.

6. The method of claim 1, wherein the calculation of subsequent reengagement comprises a calculation of an amount of time the user will engage with the content item during a future time period.

7. The method of claim 1, wherein the calculation of subsequent reengagement comprises a calculation of an amount of time that will elapse before the user reengages with the content item.

8. The method of claim 1, further comprising, for each content item of the set of content items:
obtaining a second score for the content item, the second score corresponding to a probability of a selection of the content item by the user; and
assigning a combined score to the content item by aggregating the score and the second score; and
wherein the ranking of the set of content items is in accordance with the respective combined scores.

9. The method of claim 8, wherein the second score for the content item is obtained from a second recommender system, different than the recommender system.

10. The method of claim 8, wherein the second score for each content item is based on information about the user, information about the content item, and context information.

11. The method of claim 1, wherein the score for each content item is based on (i) the calculation of subsequent reengagement by a user with the content item and (ii) a probability of a selection of the content item by the user.

12. The method of claim 1, wherein the score for each content item is based on information about the user, information about the content item, context information, and information about types of short-term outcomes for content items.

13. The method of claim 12, wherein the types of short-term outcomes include one or more of: the user selecting the content item to watch, the user watching the content item, and the user adding the content item to a favorites list.

14. The method of claim 1, wherein the set of content items includes one or more of: a podcast series, a show series, an audiobook series, and a music playlist.

15. The method of claim 1, wherein the score for each content item corresponds to a likelihood of consumption of the content item affecting a habit of the user.

16. The method of claim 1, wherein the set of content items comprises content items not previously engaged with by the user.

17. The method of claim 1, wherein the recommender system is trained using a reward function.

18. The method of claim 1, wherein the score for the content item comprises a difference score for reengagement, and wherein the difference score corresponds to a difference between a first reengagement score without a recommendation and a second reengagement score with the recommendation.

19. A computing device, comprising:
one or more processors;
memory; and
one or more programs stored in the memory and configured for execution by the one or more processors, the one or more programs comprising instructions for:
for each content item of a set of content items, obtaining a score for the content item using a recommender system, the score corresponding to a calculation of subsequent repeated engagement by a user with the content item;
ranking the set of content items based on the respective scores; and
providing recommendation information to the user for one or more highest ranked content items in the set of content items.

20. A non-transitory computer-readable storage medium storing one or more programs configured for execution by a computing device having one or more processors and memory, the one or more programs comprising instructions for:
for each content item of a set of content items, obtaining a score for the content item using a recommender system, the score corresponding to a calculation of subsequent repeated engagement by a user with the content item;
ranking the set of content items based on the respective scores; and
providing recommendation information to the user for one or more highest ranked content items in the set of content items.
